(19) United States
(12) Patent Application Publication
(10) Pub. No.: US 2011/0242045 A1
(43) Pub. Date: Oct. 6, 2011

(54) NOISE BLOCKING IN A CAPACITIVE TOUCH DEVICE

(76) Inventors: TAE KWANG PARK, San Jose, CA (US); ARUN JAYARAMAN, San Ramon, CA (US)

(21) Appl. No.: 12/755,238

(22) Filed: Apr. 6, 2010

(51) Int. Cl. G06F 3/045

(52) U.S. Cl. 345/174

(57) ABSTRACT

A touch controller to be used by a touch screen device to provide a touch position is disclosed, including a plurality of capacitance sensing channels that each provide an analog signal responsive to a touch on a screen; a channel multiplexer to select at least one of the plurality of channels; an analog-to-digital converter to change the analog signal of the selected capacitance sensing channel to a digital signal; a noise detecting channel coupled to a noise analog-to-digital converter to generate a noise digital signal; a noise blocking timing generation block that combines a time shifted digital signal and a blocking signal, wherein the time shifted digital signal is formed by time shifting the digital signal and the blocking signal is related to the noise signal; a capacitance calculating block coupled to the noise blocking time generation block to calculate capacitance values for each of the capacitance sensing channels; and a position calculation unit to find the touch position on the screen based on the capacitance values for each of the capacitance sensing channels.

### BACKGROUND

1. Field of the Invention

The present invention relates to a touch sensor and, more specifically, to circuits and methods for blocking noise in a touch device.

2. Description of Related Art

To remove external noise in touch sensitive devices, a noise insulation film is commonly inserted between a touch screen panel and a LCD display panel. However, adding an extra film to isolate the touch device from external noise involves an extra manufacturing step, which increases device cost and complexity.

Another approach includes logically averaging several data frames and filtering those data frames using different computational techniques. However, averaging methods, although effective in eliminating noise from the signal, are time-consuming, making the touch response time much slower and less sensitive to sudden stimuli from the user.

Therefore, there is a need for noise blocking to remove external and internal noise in touch sensitive devices in a fast manner. Further, it is beneficial if noise blocking is accomplished without increasing the cost and complexity of fabrication of the touch sensitive device or slowing its operational response time.

### SUMMARY

A touch controller to be used by a touch screen device to provide a touch position is disclosed. The touch controller includes a plurality of capacitance sensing channels that each provide an analog signal responsive to a touch on a screen; a channel multiplexer to select at least one of the plurality of channels; an analog-to-digital converter to change the analog signal of the selected capacitance sensing channel to a digital signal; a noise detecting channel coupled to a noise analog-to-digital converter to generate a noise digital signal; a noise blocking timing generation block that combines a time shifted digital signal and a blocking signal, wherein the time shifted digital signal is formed by time shifting the digital signal and the blocking signal is related to the noise signal; a capacitance calculating block coupled to the noise blocking time generation block to calculate capacitance values for each of the capacitance sensing channels; and a position calculation unit to find the touch position on the screen based on the capacitance values for each of the capacitance sensing channels.

Also provided is a touch screen device for finding a touch position on a screen and performing operations based on the touch position, further including a host processor to perform operations based on the touch position; an LCD panel having a display image; a touch panel coupled to the LCD panel and coupled to a touch controller; an LCD noise antenna coupled to the touch panel and coupled to the touch controller; an LCD driver circuit coupled to the LCD panel to provide the display image; wherein the touch controller provides a touch position. The touch controller may further include a plurality of capacitance sensing channels that each provide an analog signal responsive to a touch on a screen; a channel multiplexer to select at least one of the plurality of channels; an analog-to-digital converter to change the analog signal of the selected capacitance sensing channel to a digital signal; a noise detecting channel coupled to a noise analog-to-digital converter to generate a noise digital signal; a noise blocking timing generation block that combines a time shifted digital signal and a blocking signal, wherein the time shifted digital signal is formed by time shifting the digital signal and the blocking signal is related to the noise signal; a capacitance calculating block coupled to the noise blocking time generation block to calculate capacitance values for each of the capacitance sensing channels; and a position calculation unit to find the touch position on the screen based on the capacitance values for each of the capacitance sensing channels.

These and other embodiments of the present invention are further described below with reference to the following figures.

### BRIEF DESCRIPTION OF THE FIGURES

FIG. 1. Shows a diagram of a touch screen panel with a display, including a touch controller, according to some embodiments of the present invention.

FIG. 2. Shows a block diagram with operational elements of a touch controller, according to some embodiments of the present invention.

FIG. 3. Shows a circuit diagram of an analog capacitance-to-digital converter in a touch controller according to some embodiments of the present invention.

FIG. 4. Shows a block diagram of a touch controller with a noise blocking timing generator circuit and a noise analog-to-digital converter circuit according to some embodiments of the present invention.

FIG. 5. Shows a circuit diagram of a noise analog-to-digital converter according to some embodiments of the present invention.

FIG. 6. Shows a block diagram of a noise blocking timing generator circuit according to some embodiments of the present disclosure.

FIG. 7. Shows a series of waveform traces reproducing the operation of a touch controller as disclosed in some embodiments of the present invention.

Wherever possible, the same reference numbers are used throughout the drawings to refer to the same or like elements.

### DETAILED DESCRIPTION

Generally, the touch sensor element of a touch controller in a touch sensitive device is located in the vicinity of high noise components. For example, in the case of a touch screen panel, the touch sensor element is commonly placed in the upper side of the display panel. In the case of touch buttons, touch sensor elements are usually located close to the power generating device. To prevent detection of unexpected noise generated from an external source, some embodiments of the invention disclosed herein introduce a digitized phase-shifting stage and a noise-blocking stage. The digitized phase-shifting stage includes an analog-to-digital conversion of a detected noise and a phase shifting of the digitized data. In some embodiments of the present invention, the digitized data includes a series of capacitance values. The noise-blocking stage avoids capacitive bit counting during a time period when the signal is dominated by noise.

Touch sensors are generally very sensitive to outside environmental conditions such as humidity, temperature, radio-frequency noise (RF) or any other external noise. This sensitivity normally leads to unstable touch location results caused by the external noise. In some embodiments of the present invention, signals that are generated externally from the touch device may be part of a signal transmission related to other devices. In some embodiments a floating background signal may be present. According to some embodiments of the present invention, signals may not correspond to a touch provided by the user and are regarded as ‘noise’. In addition, there may be other internal sources of noise, such as noise produced by a power generating element in the touch-screen device. Further, common signal noise produced by the operation of a liquid crystal display (LCD) device attached to the touch sensor. These noise sources may be separated from a ‘true’ touch signal and eliminated, according to some embodiments of the present invention.

In some embodiments of a capacitive touch screen, the touch controller amplifies small differences between the capacitance in each sensing channel and a reference capacitor. The analog capacitance difference is converted to a digital value by using an analog capacitance-to-digital converter circuit. After filtering and amplifying a sequence of those digitized bits for all sensing channels, the touch controller calculates the ‘true’ touch position, whether the touch was made by a finger or a touch-pen. If there is any noise from an external source or an internal source, the capacitance value of each channel may be spuriously altered. Moreover, the analog capacitance-to-digital converter circuit can be affected by this high noise source even after a ‘true’ touch signal has been detected. As a result, the touch position may become unstable and unreliable.

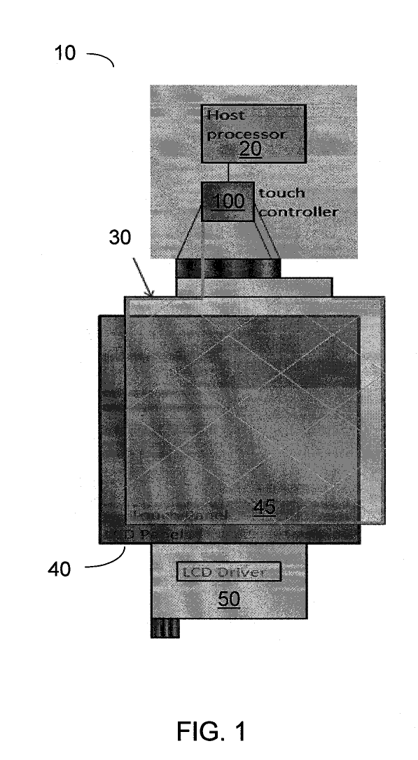

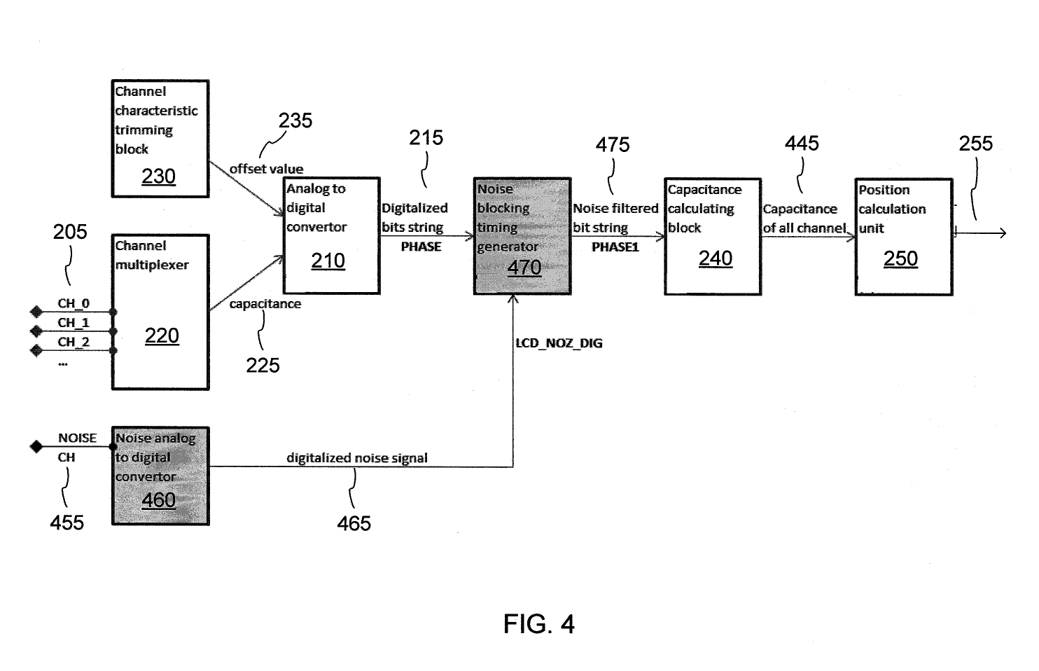

FIG. 1 shows a diagram of the hardware for a touch screen panel with display 10 according to some embodiments of the present invention. Host processor 20 is coupled to touch controller 100 to perform all operations required by touch screen device 10. These operations may use the touch position signal provided by touch controller 100. Also shown in FIG. 1 is an LCD noise antenna 30, placed next to LCD panel 40, which is controlled by LCD driver 50. In the exemplary embodiment depicted in FIG. 1, antenna 30 acts as a noise-sensitive channel that provides a noise signal to a noise analog to digital converter (cf. FIG. 4). LCD panel 40 is coupled to touch panel 45 having touch sensitive elements. The touch sensitive elements in touch panel 45 may be capacitance sensing channels, according to some embodiments depicted in FIG. 1.

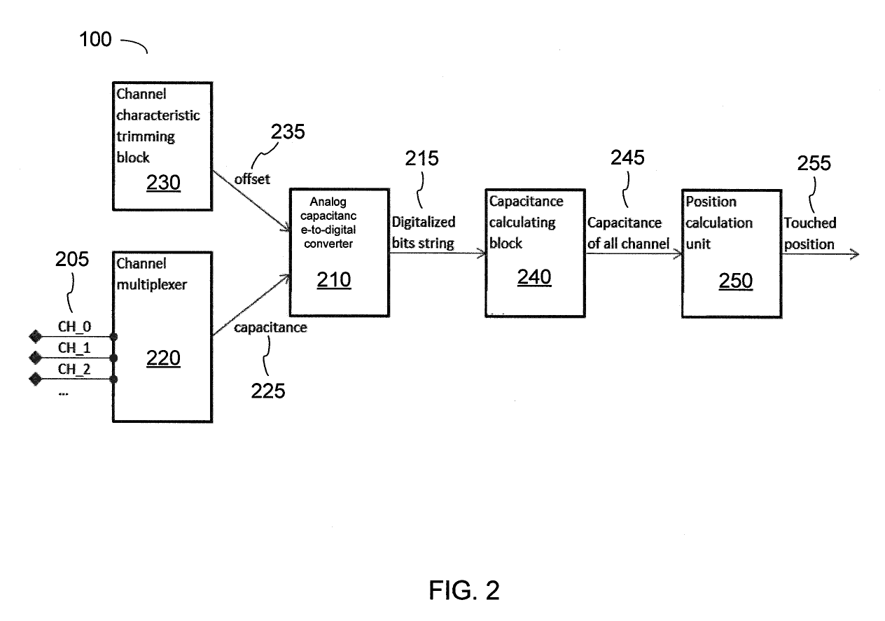

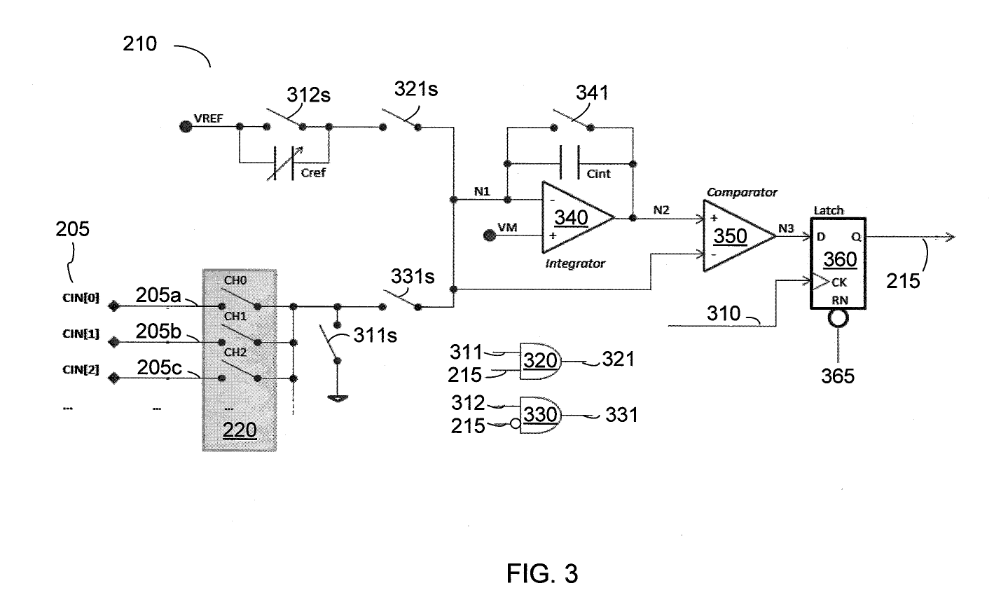

FIG. 2. depicts a block diagram of an embodiment of touch controller 100. Touch controller 100, as shown in FIG. 2, includes the following block elements: channel multiplexer 220, to select one or more of the sensing channels 205; analog-to-digital converter 210, to change the sensed analog signal 205 to a series of digital bits 215; and channel characteristic trimming block 230. Trimming block 230 corrects the analog data from each of the channels according to the particular characteristics of that channel. Block 230 provides an offset value 235 to converter 210, compensating the difference between the signal in each channel and an ambient variance. Also included in the embodiment depicted in FIG. 2 is capacitance calculating block 240, to calculate a capacitance value from the series of digital bits 215 provided by converter 210. Position calculating unit 250 may be used in touch screen controller 100 to provide a touch position. In some embodiments of the present invention, touch screen controller 100 may include a slide button controller. Digital converter 210 converts the capacitance value of each selected channel 205 into a digital bit string 215. Converter 210 will be described in detail according to some embodiments of the present invention illustrated in FIG. 3.

FIG. 3. shows a circuit diagram of an analog capacitance-to-digital converter 210 in touch controller 100 according to some embodiments of the present invention. Capacitance sensing channels 205a-205c are coupled to the touch sensitive elements in touch panel 45 (cf. FIG. 1). The signal from channels 205a-205c is input to converter 210 via multiplexer 220, opening switch 311s while closing switch 331s. A voltage, V_{ref}, for the circuit is provided by closing switch 312s and closing switch 321s. A reference signal, governed by capacitor C_{ref}, is provided by opening switch 312s and closing switch 321s, while switch 311s couples capacitance sensing channels 205a-205c to ground.

The capacitance signal and the reference signal are integrated by circuit 340. In some embodiments of the present invention circuit 340 may be an amplifier circuit coupled to a capacitor, Cᵢₙₜ. Integrator 340 is activated by ‘sync’ signal 341. The capacitance signal from capacitance sensing channels 205 and the reference signal C_{ref} thus integrated are compared by comparator circuit 350. Comparator 350 provides an input bit to latch 360, which is activated by enable bit 365 and clock signal 310, to produce signal bit string 215. According to some embodiments of the present invention illustrated in FIG. 3, the activation signal for switches 321s and 331s is provided by ‘AND’ gate 320 and ‘AND NOT’ gate 330, respectively. ‘AND’ gate 320 combines signal 311 to switch 311s and bit string 215, to generate signal 321 to switch 321s. ‘AND NOT’ gate 330 combines signal 312 to switch 312s with bit string 215 to generate signal 331, to switch 331s.

According to the exemplary embodiment depicted in FIG. 3, analog-to-digital converter circuit 210 generates bit string 215 in synchronization with clock 310. The frequency of the resulting bits in bit string 215 is proportional to the capacitance of sensing channels 205a-205c. In other words bit string 215 may have bits ‘packed’ more closely together in a time sequence upon an increase in the capacitance coupled to sensing channels 205a-205c. Furthermore, according to some embodiments of the present invention, the time width of the bits in bit string 215 is determined by the width of signals provided to switch 311s and switch 312s. It is understood that the exemplary embodiment depicted in FIG. 3 includes sensing channels 205a-205c, but the number of capacitance sensing channels is arbitrary and may be determined by specific design considerations. In some embodiments of the present invention, more capacitance sensing channels may be needed.

FIG. 4 shows a block diagram of touch controller 100 with noise analog-to-digital converter 460 and noise-blocking time generator circuit 470, according to some embodiments of the present invention. Analog-to-digital converter 210 is discussed with respect to FIG. 3. Similarly, channel characteristic trimming block 230, channel multiplexer 220, capacitance calculating block 240, and position calculation unit 250 are discussed with respect to FIG. 2.

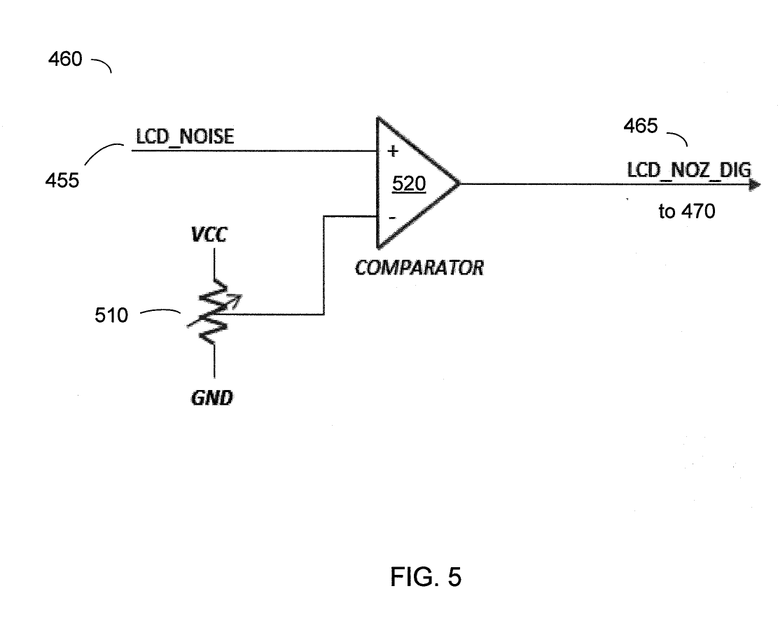

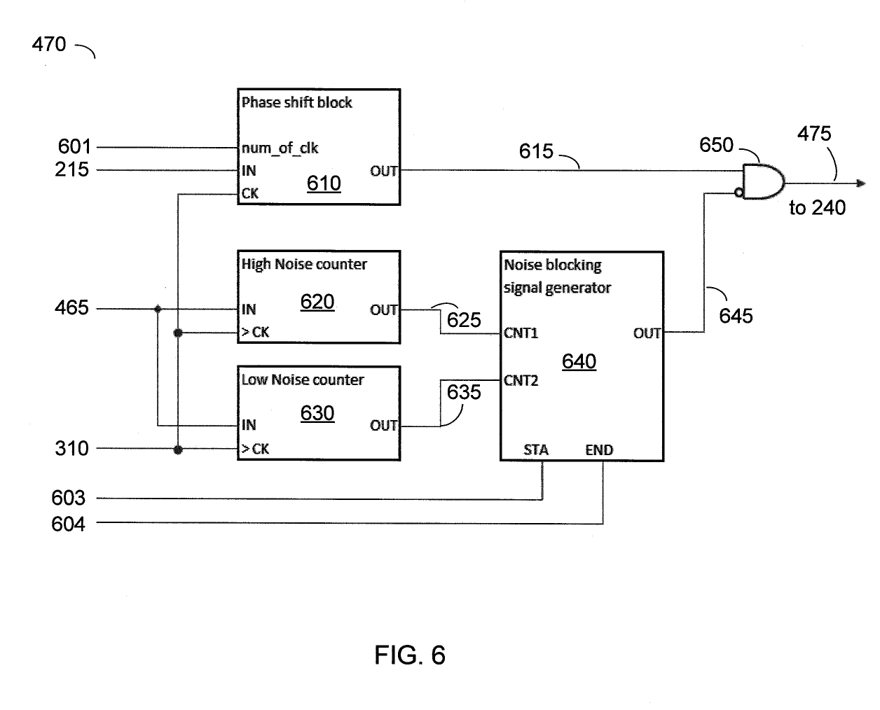

To detect noise, some embodiments of the present invention include noise analog-to-digital converter unit 460. To block the noise signal from the true touch signal, some embodiments of the present invention may include noise-blocking timing generator circuit 470. Converter 460 collects an external noise signal provided by noise detecting channel 455. In some embodiments, a noise detecting channel 455 may be one of the non-selected capacitance sensing channels (i.e. a signal channel not currently involved in a ‘true’ touch). Converter 460 changes the noise signal to digitized noise signal 465 using analog-to-digital converter circuit 460. In some embodiments of the present invention, converter 460 includes a noise comparator that uses a controllable reference voltage, as shown in FIG. 5. Timing generator 470 shifts digital bit string 215 for a selected amount of clock periods to account for noise detection delay time. Timing generator circuit 470 will be described in more detail in relation to FIG. 6, below.

FIG. 5 shows a circuit diagram illustrating noise analog-to-digital converter 460 according to some embodiments of the present invention. Converter 460 includes comparator circuit 520 that compares noise signal 455—e.g. LCD noise—to a reference voltage 510. Normally, it takes from about several hundred nano-seconds to a few micro seconds for noise comparator 520 to detect a noise edge, because some noise signals such as LCD common noise have slow transition time to reach a specific voltage level. In some embodiments of the present invention, reference voltage 510 may be varied according to the specific application of touch controller 100, or according to the specific type of noise source that is being targeted.

FIG. 6 shows a block diagram of noise blocking timing generator 470 according to some embodiments of the present disclosure. Timing generator circuit 470 includes phase shift block 610. Block 610 receives input bit string 215 from converter 210 (FIGS. 2 and 3) and provides phase-shifted bit string 615. Bit string 615 is analogous to bit string 215, except that it is shifted in time by a predetermined number ‘M’ 601 of clock signal cycles 310. In some embodiments of the present invention, the value of number ‘M’ 601 may be provided by noise blocking signal generator 640. In some embodiments, number ‘M’ 601 may be provided to shift block 610 by processor 20 (cf. FIG. 1).

According to some embodiments of the present invention, the value ‘M’ 601 is an integer number of clock pulses. The number ‘M’ 601 of clock pulses may include the time it takes converter 460 (cf. FIG. 4) to produce digitized noise signal 465, and the time it takes generator 640 (cf. FIG. 6) to generate noise blocking signal 645. In some embodiments, the number ‘M’ 601 of clock pulses may include the rise/fall time to trigger comparator 520 ‘on’ and ‘off’. In some embodiments, the number ‘M’ 601 of clock pulses may include the propagation delay of the signal through comparator circuit 460.

According to some embodiments of the present invention, timing generator circuit 470 includes a ‘high noise’ counter circuit 620 and a ‘low noise’ counter circuit 630. ‘High noise’ and ‘low noise’ counter circuits 620 and 630 use digitized noise signal 465 provided by converter 460 and clock signal 310 as input. Counter circuits 620 and 630 count the period lengths of the high level noise signal and the low level noise signal, respectively. Thus, ‘high noise’ counter 620 provides a ‘high’ count 625 to noise blocking signal generator 640. And ‘low noise’ counter 630 provides a ‘low’ count 635 to noise blocking signal generator 640.

Signal generator 640 combines the ‘high’ count and the ‘low’ count to generate a noise blocking signal 645. According to some embodiments of the present invention, noise blocking signal 645 is obtained in generator 640 by creating a ‘start’ block sequence of ‘high’ voltage values, and an ‘end’ block sequence of ‘high’ voltage values. The ‘start’ and ‘end’ sequences are separated by a sequence of ‘low’ voltage values. The length of time between the centers of the ‘start’ and ‘end’ sequences is equal to ‘high’ noise count 625. In some embodiments of the present invention, signal 645 may be further shifted in time by a predetermined number ‘M’ 601 of clock signal cycles 310.

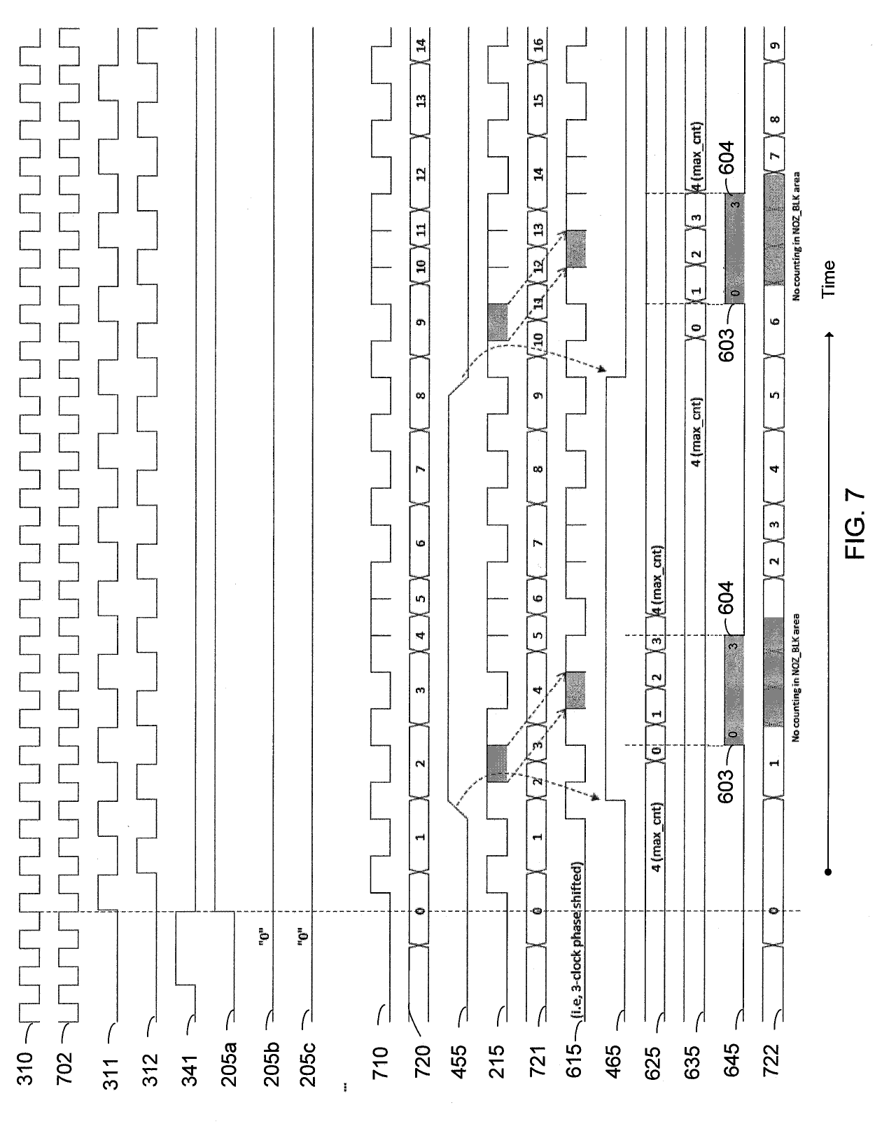

The duration of the ‘start’ and ‘end’ block sequences may be determined by input signals 603 (STA), and 604 (END). Input signals 603 and 604 may be selected from counts 625 and 635 according to the specific application of the touch sensing device. In some embodiments of the present application, the duration of the ‘start’ sequence may be selected to be equal to the ‘end’ block sequence. Further, some embodiments of the present invention may have a maximum count for the ‘start’ sequence of 4 clock periods (cf. FIG. 7, below). In some embodiments, it may be desirable to shorten the duration of the ‘start’ and ‘end’ block sequences. In some embodiments of the present invention, the duration of ‘start’ and ‘end’ block sequences may be increased, but not so as to block large sections of bit string 215, including ‘true’ touch signals.

In some embodiments of the present invention, signals 603 and 604 may be provided by host processor 20 (cf. FIG. 1) after a ‘learning’ period where a number of ‘high noise’ and ‘low noise’ signals has been registered.

According to some embodiments of block timing generator 470, noise signal 465 may have a periodic structure in time. An example of a noise blocking signal 645 and a phase shift ‘M’ 601 will be illustrated in relation to FIG. 7, below.

Noise blocking signal 645 is combined with phase-shifted string 615 by ‘AND NOT’ gate 650, to create noise-filtered bit string 475. Noise-filtered bit string 475 is input to capacitance calculating block 240 (cf. FIG. 2).

FIG. 7. Shows a series of waveform traces reproducing the operation of touch controller 100 according to some embodiments of the present invention. The traces are aligned in time, where time runs from left to right, as indicated in the figure. Clock signal 310 is provided together with a 180° phase shifted clock signal 702. Trace 311 reflects the signal provided to switch 311s, and trace 312 reflects the signal provided to switch 312s (cf. FIG. 3). According to some embodiments depicted in FIG. 7, trace 312 is shifted by 180° relative to trace 311. Also the time-width of the bits in traces 311 and 312 is about twice the time-width of clock signal 310 and signal 702. Synchronization signal 341 is provided to start the measurement process. According to the embodiment depicted in FIG. 7, capacitance sensing channels 205a, 205b and 205c provide traces as shown in the figure. Sensing channel 205a presents a high voltage level at the time the synchronization signal has turned the measurement process ‘on’, indicating a ‘true’ touch signal. Meanwhile, sensing channels 205b and 205c remain at a low value, indicating that channel multiplexer 220 (cf. FIG. 2) is currently engaging channel 205a. The embodiment depicted in FIG. 7 is not limiting and more sensing channels may be involved in the measurement. Moreover, some embodiments may provide more than one sensing channel engaged at any given time with a high signal, indicating a ‘true’ touch.

According to some embodiments of the present invention as depicted in FIG. 7, a ‘true’ signal trace 710 represents a signal string in a situation where no noise is present in the signal. A ‘true’ signal 710 includes a series of bits having each a time length determined by traces 311 and 312. The bits in trace 710 are synchronized with clock 310 and trace 702. Signal trace 710 is input to calculating block 240 (cf. FIG. 2) where a counting sequence 720 is provided. In sequence 720 each ‘high’ signal in clock 310 is counted once and added to a counter, provided signal trace 710 is ‘high’. After a measurement process is finished, according to trace 341, the total count provided by count sequence 720 is converted into a capacitance value. The capacitance value is associated to a given channel by block 240 (cf. FIG. 2). Sequence 720 is the sequence associated to the capacitance changes induced in channel 205a by a ‘true’ touch affecting the channel. Sequence 720 renders a value of ‘14’ for channel 205a, according to the embodiment depicted in FIG. 7. All capacitance sensing channels are engaged by channel multiplexer 220 and a capacitance value is associated with every capacitance sensing channel. Position calculation unit 250 uses as input the capacitance value for each of the capacitance sensing channels, provided by block 240. Calculation unit 250 obtains a location for the position in the LCD display or touch panel where the touch has taken place.

Also shown in FIG. 7, in some embodiments of the present invention a noise detecting channel may provide noise signal 455. Signal 455 may indicate that bit string 215 provided by digital converter 210 is different from bit string 710. This may be because a noise signal is embedded in the bit string. Bit string 215 is sent to capacitance calculating block 240, and count sequence 721 is obtained for channel 205a instead of ‘true’ count sequence 720. As can be seen, count sequence 721 provides an erroneous value, ‘16’, for the capacitance measurement of channel 205a. This is because two of the extra ‘high’ bit counts in trace 215 where not associated with ‘true’ touch-induced changes in the capacitance of channel 205a. Instead, the excess bit counts were associated with noise signal 455.

To prevent such an error in capacitance measurement, some embodiments of the present invention may include phase shifted bit string 615 and noise blocking signal 645. String 615 and blocking signal 645 are provided by noise blocking timing generator 470 (cf. FIGS. 4 and 6). In some embodiments of the present invention, phase shifted bit string 615 accounts for the overall time delay in processing noise signal 455 in converter 460 and generator 470. According to the embodiment depicted in FIG. 7, bit string 615 corresponds to a shift of bit string 215 by a number ‘M’ 601 of clock pulses: M=3. In this example, M=3 includes one clock pulse for propagation delay in converter 460, one clock pulse for the rise/fall time to trigger comparator 520 ‘on’ and ‘off’, and one clock pulse for the processing time of generator 640.

Also shown in FIG. 7, according to some embodiments of the present invention, digital trace 465 of noise signal 455 may be provided by noise analog to digital converter block 460 (cf. FIG. 4). Further, digital trace 465 may be shifted in time by a number ‘M’ 601 of clock pulses. And combined in noise-blocking time generator 470 (cf. FIGS. 4 and 6) with ‘high noise’ count 625 and ‘low noise’ count 635, to produce noise blocking signal 645.

According to some embodiments of the present invention depicted in FIG. 7, noise blocking signal 645 includes a ‘start’ and an ‘end’ block of high voltage values. The ‘start’ and ‘end’ blocks bracket a time period of the signal during which a high noise level is expected, according to signal 465. For example, ‘start’ block may occur before a high noise level period starts. ‘End’ block may occur after high noise level period ends. Note that, according to some embodiments depicted in FIG. 7, the blocking of the signal counting 722 only occurs during a transitional period of the noise signal. In particular, count 722 is blocked when the noise signal transits from low noise level to high noise level. Count 722 may also be blocked when the noise signal transits from high-noise level to low noise level. Thus, a relatively low number of ‘true’ touch pulses will be lost during count 722, minimizing as well the noise counts.

According to some embodiments of the present invention as depicted in FIG. 7, noise blocking signal 645 is combined with phase shifted bit string 615 by ‘AND NOT’ gate 650. Thus, a noise-free bit string 475 results (cf. FIG. 6), having a low voltage value when blocking signal 645 is high. String 475 has a high voltage value when blocking signal 645 is low, and the signal value in string 615 is high. String 475 is input to capacitance calculating block 240. Noise-blocked counting sequence 722 results, and the ‘high’ signal bits corresponding to the noise-induced bits in bit sequence 615 will not be counted. Counting sequence 722 shows a total count of ‘9’ as a result of the blocking introduced by trace 645. This value is in contrast to the value of 16 obtained for the string sequence in the presence of noise. Thus, noise blocking circuit 470 and the noise blocking method depicted in FIG. 7 results in the elimination of spurious counts induced by noise.

In some embodiments of the present invention, some counts associated with ‘true’ touch measurements may be eliminated. For example, in the embodiment depicted in FIG. 7 a noise blocked signal count 722 of ‘9’ is obtained. This is to be compared with the noise-free signal count 720 of ‘14’. Nonetheless, all of the counts considered in counting sequence 722 are associated with ‘true’ touch events, and all of the noise-induced counts are successfully removed according to the embodiment depicted in FIG. 7.

In some embodiments of the present invention, a compensation for the loss of ‘true’ counts during blocking signal 645 may be used. Here, extra clock periods may be added to match the ‘start’ block and the ‘end’ block in signal 645. The ‘start’ block and the ‘end’ block may be given by the difference between signal 604 (END) and signal 603 (STA). The extended clocking portion may be added in sections of the signal not overlapping the high noise areas. Thus, recovery of the ‘true’ counts lost during block periods 645 is possible.

Embodiments of the invention described above are exemplary only. One skilled in the art may recognize various alternative embodiments from those specifically disclosed. Those alternative embodiments are also intended to be within the scope of this disclosure. As such, the invention is limited only by the following claims.

1. A touch controller to be used by a touch screen device to provide a touch position, the touch controller comprising:
a plurality of capacitance sensing channels that each provide an analog signal responsive to a touch on a screen;
a channel multiplexer to select at least one of the plurality of channels;
an analog-to-digital converter to change the analog signal of the selected capacitance sensing channel to a digital signal,
a noise detecting channel coupled to a noise analog-to-digital converter to generate a noise digital signal;
a noise blocking timing generation block that combines a time shifted digital signal and a blocking signal, wherein the time shifted digital signal is formed by time shifting the digital signal and the blocking signal is related to the noise signal;
a capacitance calculating block coupled to the noise blocking time generation block to calculate capacitance values for each of the capacitance sensing channels; and
a position calculation unit to find the touch position on the screen based on the capacitance values for each of the capacitance sensing channels.

2. The controller of claim 1 further wherein the noise detecting channel may comprise one of the plurality of capacitance sensing channels that is not sensing a touch.

3. The controller of claim 1 further comprising a channel characteristic trimming block to provide an offset value to the analog-to-digital converter, compensating the difference between the signal in each channel and the variance of an ambient state.

4. The controller of claim 1, wherein the noise blocking timing generation block provides a bit string where the noise is substantially reduced.

5. The controller of claim 4, further comprising a clock generator, wherein the noise blocking timing generation block shifts the digital signal by several clock periods according to the noise characteristic; and
the blocking signal provided by noise blocking timing generation block is selected after calculating a blocking area from a noise edge.

6. The controller of claim 5, further wherein the shift of the digital signal by several clock pulses comprises a number of clock pulses including the time for processing the noise signal in the analog-to-digital converter and the time for processing the noise signal in the noise blocking timing generation block.

7. The controller of claim 6 wherein the noise blocking timing generation block further comprises a phase shift block to provide the time shift for the digital signal for a number of clock periods.

8. The controller of claim 7 wherein the number of clock periods for the time shift is provided by the noise blocking signal generator.

9. The controller of claim 8 wherein the number of clock periods for the time shift is provided by a processor.

10. The controller of claim 5, further wherein the blocking signal comprises a start period where the blocking signal is high and an end period where the blocking signal is high; and
the start period is separated from the end period by a period where the blocking signal is low.

11. The controller of claim 10 wherein the noise blocking timing generation block further comprises:
a high noise counter to count the clock periods during which a noise signal is high, providing a high noise period; and
a low noise counter to count the clock periods during which a noise signal is low, providing a low noise period.

12. The controller of claim 11 wherein the noise blocking timing generation block further comprises a noise blocking signal generator that generates the blocking signal from the high noise period, the low noise period, a start signal and an end signal.

13. The controller of claim 12 wherein the period separating the middle of the start period from the middle of the end period is substantially the same as the high noise period.

14. The controller of claim 5 wherein the noise-free bit string has a high voltage value when the time shifted digital signal is high and the blocking signal is low; and
the noise-free bit string has a low voltage value when the blocking signal is high; and further wherein
the noise-free bit string has a low voltage value when the time-shifted signal string is low.

15. The controller of claim 14 wherein the capacitance calculating block provides a count of the bits in the noise-free bit string by increasing the count when the clock signal is high and the noise-free bit string signal is high.

16. A touch screen device for finding a touch position on a screen and performing operations based on the touch position, further comprising:
a host processor, to perform operations based on the touch position;
an LCD panel having a display image;
a touch panel coupled to the LCD panel and coupled to a touch controller;
an LCD noise antenna coupled to the touch panel and coupled to the touch controller;
an LCD driver circuit coupled to the LCD panel to provide the display image; wherein
the touch controller provides a touch position, the touch controller further comprising:
a plurality of capacitance sensing channels that each provide an analog signal responsive to a touch on a screen;
a channel multiplexer to select at least one of the plurality of channels;
an analog-to-digital converter to change the analog signal of the selected capacitance sensing channel to a digital signal,
a noise detecting channel coupled to a noise analog-to-digital converter to generate a noise digital signal;
a noise blocking timing generation block that combines a time shifted digital signal and a blocking signal, wherein the time shifted digital signal is formed by time shifting the digital signal and the blocking signal is related to the noise signal;
a capacitance calculating block coupled to the noise blocking time generation block to calculate capacitance values for each of the capacitance sensing channels; and
a position calculation unit to find the touch position on the screen based on the capacitance values for each of the capacitance sensing channels.

17. The touch screen device of claim 16, wherein the noise blocking timing generation block provides a bit string where the noise is substantially reduced.

18. A method for blocking noise in a touch screen device, the method comprising the steps of:
collecting an analog signal from at least one of a plurality of capacitance sensing channels;
converting the analog signal into a digital signal;
collecting a noise signal from a noise detecting channel;
shifting the timing of the digital signal using a phase-shift block, and blocking a portion of the time shifted signal to avoid counting the noise signal;
calculating the capacitance of each of the plurality of capacitance sensing channels; and
finding the touch position from the capacitance calculated for each of the plurality of capacitance sensing channels.

19. The method of claim 18 wherein calculating the capacitance of each of the plurality of capacitance sensing channels further comprises:
using a clock generator to provide a clock signal;
using a noise blocking timing generator to provide a bit string where the noise is substantially reduced; and
providing a count, wherein providing a count further comprises
counting the bits in the bit string where the noise is substantially reduced using the clock signal.
